(19) United States
(12) Patent Application Publication
(10) Pub. No.: US 2012/0000042 A1
(43) Pub. Date: Jan. 5, 2012

(54) Bottle and Key Clip

(75) Inventor: Nicholas J. Pappas, Westport, CT (US)

(73) Assignee: MEDIALORE, LLC, Westport, CT (US)

(21) Appl. No.: 13/176,367

(22) Filed: Jul. 5, 2011

Related U.S. Application Data
(60) Provisional application No. 61/360,944, filed on Jul. 2, 2010.

(51) Int. Cl. F16B 45/00

(52) U.S. Cl. 24/598.4

(57) ABSTRACT

A mechanism/device is provided for use with a container or vessel or other object and, more particularly, a device for use with a bottle to assist in securing such bottle to a belt, belt loop, strap, hook or other hanging device while not in use and further allowing the securing of objects such as keys and key rings, and further allowing addition of personalizing accessories to the subject device.

### 1. TECHNICAL FIELD

The present disclosure relates to a device for use with a container or vessel or other object and, more particularly, to a device for use with a bottle to assist in securing such bottle to a belt, belt loop, strap, hook or other hanging device while not in use and further allowing the securing of objects such as keys and key rings, and further allowing addition of personalizing accessories to the subject device.

### 2. BACKGROUND OF THE DISCLOSURE

It is often advantageous to have a means of conveniently securing bottles, keys, key rings and other objects in a readily accessible location yet without requiring the use of appendages to hold such items. Generally, there are applications which address these needs independently; e.g. there may be a clip to secure a bottle or other container, and there may be a clip to secure key(s) or a key-ring.

In certain circumstances, it may be advantageous to provide one clip which can conveniently secure a bottle or other container or object, while at the same time securing another object such as key(s), a key-ring or other object which may conveniently fit. Further, to allow the user to personalize the device as (s)he sees fit, it is advantageous to provide a means to easily decorate or personalize the device with an accessory or accessories.

Efforts have been devoted in the prior art to developing devices and/or systems for securing bottles to carabiner clips and similar clips. U.S. Design Patent No. D491,465 describes a ring which attaches to a bottle neck and to a clip. There are also effort devoted in the prior art to developing devices and/or systems for securing key(s) and or key ring(s); Lucky Line Products, Inc. manufactures such items including its “Quik Clip”. There are also efforts devoted in the prior art to developing devices and/or systems to allow personalizing objects with other objects, such as those known as “Jibbitz” for use with shoes known as “Crocs.”

Despite the efforts referenced hereinabove, a need remains for advantageous devices that conveniently combine these features.

### 3. SUMMARY OF THE DISCLOSURE

The present disclosure is directed to a device for securing a bottle, vessel or other container, and/or a key ring, to a belt, belt loop, strap, hook, and the like, and which has a means to allow personalizing decoration at the tab end of the device, particularly through insertion of an accessory through an open slot. The disclosed device may be advantageously employed in a variety of applications where it is desired to secure containers, keys, and/or key rings so that the user is not required to hold them in hand or pocket or bag while not in use, thus freeing use of hand(s) and increasing available space in pocket or bag as well as securing containers and keys in a more convenient and readily accessible location. The disclosed device may also be pre-mounted to a container/vessel/bottle, e.g., in the manufacturing process. In such circumstance, the present disclosure is directed to the container/vessel/bottle in combination with such advantageous device.

Additional features, benefits and functionalities associated with devices and bottle/key clips according to the present disclosure will be apparent from the detailed description which follows.

### 4. BRIEF DESCRIPTION OF THE FIGURES

The features, benefits and functionalities of the present disclosure will become more readily apparent to those skilled in the art from the following detailed description of preferred embodiment(s) when considered together with the accompanying images, wherein:

FIG. 1 is a front view of an exemplary embodiment of a bottle and key clip device with personalizable slot according to the present disclosure;

FIG. 2 is a perspective view of a bottle and key clip device with personalizable slot and showing a personalizing accessory, according to the present disclosure;

FIG. 3 is a front view of an exemplary embodiment of a bottle and key clip device with personalizable slot, with key ring attached and personalizing accessory inserted in slot, according to the present disclosure; and

FIG. 4 is a perspective view of an exemplary embodiment of a bottle and key clip device with personalizable slot, with key ring and bottle attached, personalizing accessory inserted in slot, and clip hanging from belt loop, according to the present disclosure.

FIG. 5A and FIG. 5B are a front and a side view of an exemplary embodiment of a flexible ring bottle holder which attaches to a flexible opening and closing clip, such as the example shown in FIGS. 1 through 4, and which is advantageously shaped to assemble more easily with less resistance, and which optionally provides a personalizable slot and/or recessed edges to accommodate a variety of personalizing accessories, according to the present disclosure.

### 5. DETAILED DESCRIPTION OF PREFERRED EMBODIMENT(S)

The device of the present disclosure advantageously secures either keys or bottle or other container, or both, and further allows addition of a personalizing accessory in a slot at the tab. The device may be provided as a free standing item, e.g., an accessory unit/assembly for independent purchase and use, or as part of an integrated product offering, e.g., permanently or detachably secured to a container, vessel or bottle. The disclosed device may be employed in a variety of applications, e.g., to secure keys, key rings, bottles and the like.

In an exemplary application of the present disclosure, the device may be employed in connection with securing a bottle and/or keys without holding them directly or storing them in another conveyance, such as a bag, pocket, and the like. The disclosed device allows the user to conveniently hang the device and secured item(s) in a more readily accessible or preferred location. The disclosed device is advantageously sized and dimensioned to be utilized with most standard size bottles, key rings and personalizing accessories, as are known in the art. Adjustments to the size and/or dimensions of the disclosed device and its components may be made to facilitate use with non-conventionally sized fluid bottles, key rings, and other accessories, as is apparent from the detailed description provided herein.

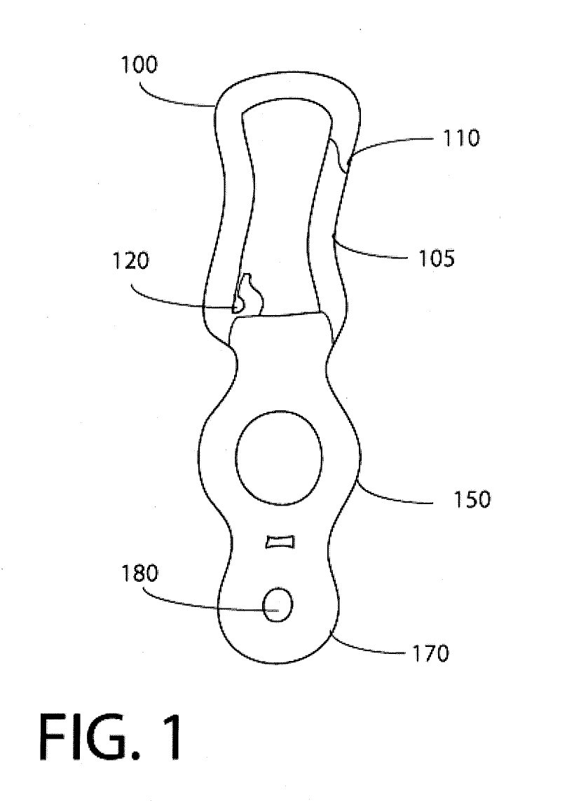

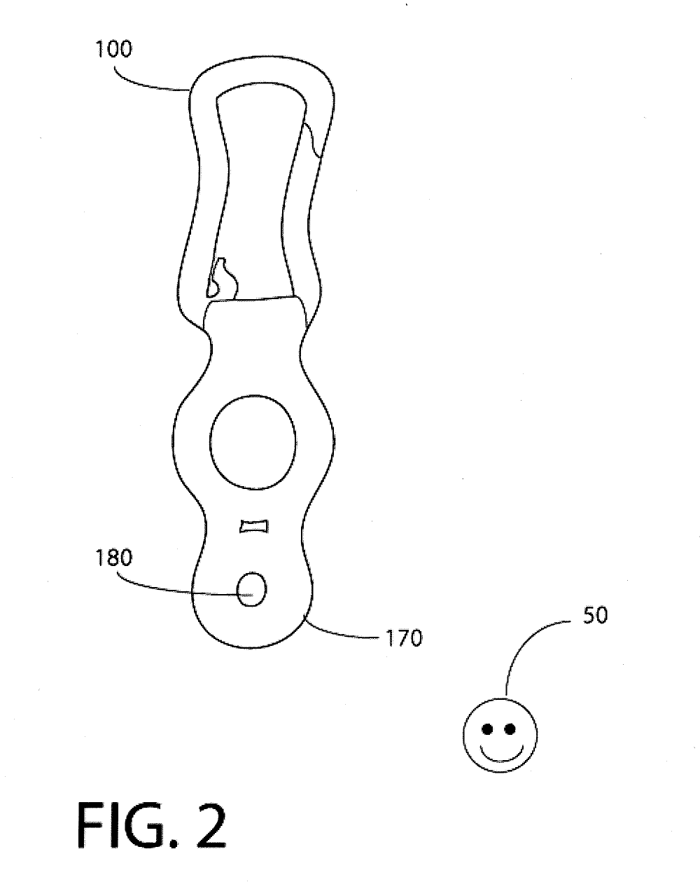

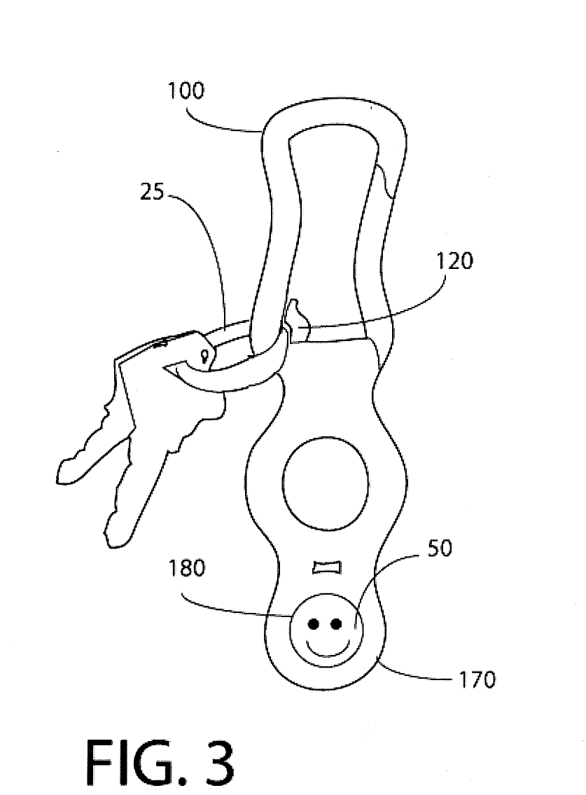

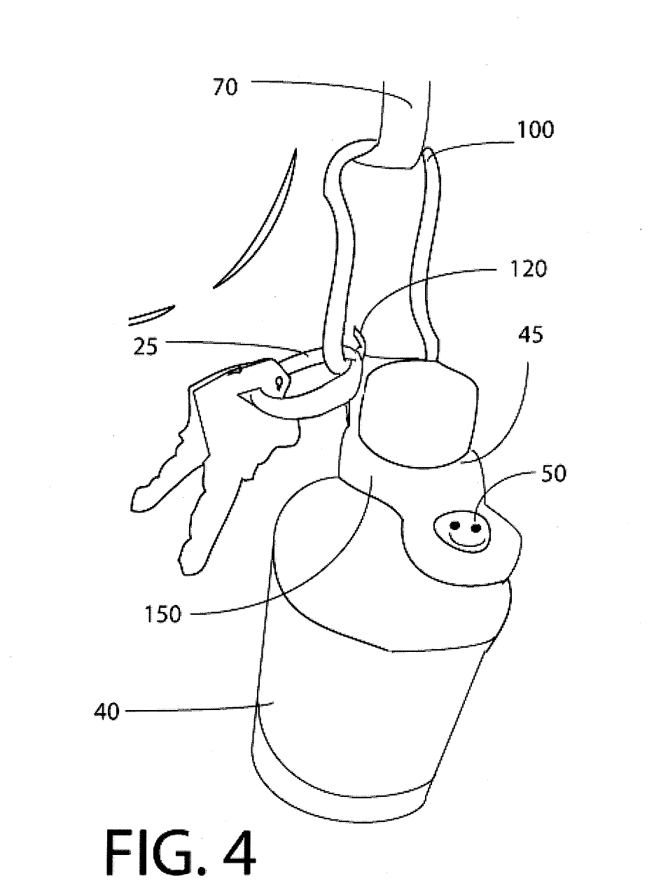

With reference to FIGS. 1-4, an exemplary bottle and key clip device 100 according to the present disclosure is depicted for use, showing an optional interior hook 120 to receive keys or key ring 25 (FIGS. 3 and 4), a flexible ring 150 which fits around the neck of a conventional bottle neck 45 (as shown in FIG. 4), and a flexible opening and closing clip 105 which attaches to a belt, loop, strap, or other hanging apparatus. A tab 170 which may be used to help pull flexible ring 150 onto and off bottle neck 45 may optionally have a slot 180 to receive a personalizing accessory 50 as shown in FIGS. 2-4, as is known in the art. Bottle and key clip device 100 may be used, inter alia, as a bottle clip, key clip, or both.

With reference to bottle and key clip device 100, the overall assembly generally includes two (2) distinct components as shown in FIG. 1: clip 105 and flexible ring 150. With further reference to FIG. 1, when the center area of clip 105 is squeezed inwardly, a separation occurs at location 110 allowing keys, key rings and other items to slide into clip 105 and further allows bottle and key clip 100 to fit through a belt, loop, strap or other similar hanging device by allowing such belt, loop, strap or other hanging device to travel through the opening created at location 110. When the squeezing or inwardly directed pressure is removed, opening 110 reverts to its sealed position.

FIG. 4 shows bottle and key clip 100 hanging from belt loop 70, with flexible ring 150 around neck 45 of bottle 40; key ring 25 is captured within interior hook 120 and further shows the attached personalizing accessory 50.

In an alternative embodiment, with reference to FIG. 1, bottle and key clip device 100 may be formed without interior hook 120. In such a case, the keys or key ring would rest against ring 150 in the area where interior hook 120 would otherwise have been, or against ring 150 on the other side, opposite where interior hook 120 would otherwise have been.

In a further alternative embodiment, hook 120 could be located elsewhere on the interior or even on exterior edge of clip 105.

In a further alternative embodiment, with reference to FIG. 1, tab 170 may be formed without slot 180, i.e. solid, and be decorated with stickers, graphics, inks, dyes or other applied decorations.

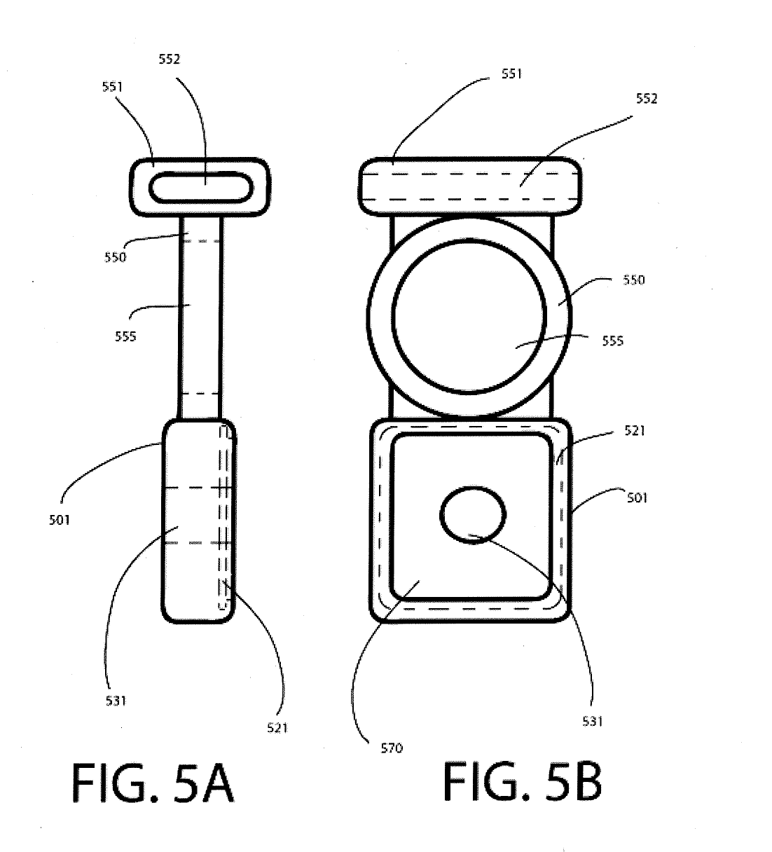

In a further alternative embodiment, with reference to FIGS. 1 through 4 and FIGS. 5A and 5B, flexible ring 550 may be formed with tab 501 and be more advantageously shaped with oblong attachment area 551 and 552 to fit a non-rounded, e.g., oblong-edged, clip such as clip 105 shown in FIGS. 1-4. Assembly of an oblong-edged clip, such as clip 105 with a flexible ring 550 including oblong-shaped areas 551 and 552, would be more easily facilitated with an oblong opening 552 rather than a round opening; oblong-edged clips such as clip 105 would slide more easily through oblong opening 552 without the added tension, resistance and friction encountered in stretching a round opening typically found in the current art. Tab 501 may optionally include opening 531 in order to receive a personalizing accessory 50. Tab 501 may also optionally include, either with or without opening 531, a recessed edge or rim 521 which may receive and secure the edges of an accessory piece which may be a personalized image, photo or other two-dimensional or three-dimensional design on paper, plastic or in other material, which would be mounted and displayed in area 570 and which may or may not also include clear plastic cover(s) to protect said image or design. A bottle 40 would be secured as in FIG. 4, with bottle neck 45 captured by flexible ring 550, through opening 555 shown in FIG. 5.

Although the devices of the present disclosure, e.g., bottle and key clip device, have been described with reference to exemplary embodiments thereof, the present disclosure is not to be limited to the specifics of the disclosed embodiments, but is to be broadly understood. The disclosed embodiments are merely illustrative, and not limitative, of the scope of the present invention, and changes, modifications and/or variations may be utilized without departing from the spirit or scope of the present invention.

1. A device comprising:
(a) a clip with hook for securing one or more keys or key rings,
(b) a flexible binding secured to said clip, said flexible binding being configured and dimensioned to fit around part of a container, vessel or other object, said flexible binding further including a slot that is configured and dimensioned to permit addition of one or more accessories thereto.

2. The device according to claim 1, wherein the slot is adapted to allow a user to personalize the device.

3. The device according to claim 1, wherein the flexible binding is adapted to be detachably secured relative to a belt, loop, strap or hook.

4. A device comprising:
(a) a clip with hook for securing one or more keys or key rings,
(b) a flexible binding secured to said clip, said flexible binding being configured and dimensioned to fit around part of a container, vessel or other object, said flexible binding including a solid tab.

5. The device according to claim 4, wherein the flexible binding is adapted to be detachably secured relative to a belt, loop, strap or hook.

6. A device comprising:
(a) a clip with hook for securing one or more keys or key rings,
(b) a flexible binding secured to said clip, said flexible binding being configured and dimensioned to fit around part of a container, vessel or other object, said flexible binding including a recessed edge or rim that is adapted to receive and secure one or more accessories relative thereto.

7. The device according to claim 6, wherein the flexible binding is adapted to be detachably secured relative to a belt, loop, strap or hook.

8. The device according to claim 6, wherein the recessed edge or rim is adapted to allow a user to personalize the device.

9. The device according to claim 6, wherein the flexible binding further comprises a slot that is configured and dimensioned to permit addition of one or more accessories thereto.

10. A device comprising:
(a) a clip for securing one or more keys or key rings,
(b) a flexible binding secured to said clip, said flexible binding being configured and dimensioned to fit around part of a container, vessel or other object, said flexible binding including a recessed edge or rim that is adapted to receive and secure one or more accessories relative thereto.

11. The device according to claim 10, wherein the flexible binding further comprises a slot that is configured and dimensioned to permit addition of one or more accessories thereto.
